(19) United States
(12) Patent Application Publication
(10) Pub. No.: US 2022/0234526 A1
(43) Pub. Date: Jul. 28, 2022

(54) WIRING MEMBER

(71) Applicants: AutoNetworks Technologies, Ltd., Mie (JP); Sumitomo Wiring Systems, Ltd., Mie (JP); SUMITOMO ELECTRIC INDUSTRIES, LTD., Osaka (JP)

(72) Inventors: Shintaro SUMIDA, Mie (JP); Motohiro YOKOI, Mie (JP); Kenta ITO, Mie (JP); Suguru YASUDA, Mie (JP); Tetsuya NISHIMURA, Mie (JP); Hitomi HARADA, Mie (JP); Haruka NAKANO, Mie (JP); Ryusuke KUDO, Mie (JP); Hiroki HIRAI, Mie (JP)

(73) Assignees: AutoNetworks Technologies, Ltd., Mie (JP); Sumitomo Wiring Systems, Ltd., Mie (JP); SUMITOMO ELECTRIC INDUSTRIES, LTD., Osaka (JP)

(21) Appl. No.: 17/611,749

(22) PCT Filed: May 14, 2020
(86) PCT No.: PCT/JP2020/019193

§ 371 Date: Nov. 16, 2021

(30) Foreign Application Priority Data
May 31, 2019 (JP) 2019-102898

(51) Int. Cl. B60R 16/02; H01B 7/08; H01B 7/36; H02G 3/04

(52) U.S. Cl. CPC B60R 16/0215; H02G 3/0406; H01B 7/36; H01B 7/0823

(57) ABSTRACT

A wiring member includes: a plurality of wire-like transmission members; and a sheet to which the plurality of wire-like transmission members are fixed to be arranged side by side, wherein the sheet includes a first sheet covering the plurality of wire-like transmission members from one side and a second sheet covering the plurality of wire-like transmission members from another side, a window region is provided in a part of the sheet along a longitudinal direction of the plurality of wire-like transmission members, the window region is provided on a side directed to an outer surface in a state where the wiring member is folded, and a part of the plurality of wire-like transmission members wired in the window region can be identified.

### TECHNICAL FIELD

The present disclosure relates to a wiring member.

### BACKGROUND ART

Patent Document 1 discloses a wire harness in which an electrical wire is welded to a functional exterior member formed into a sheet-like shape.

### PRIOR ART DOCUMENTS

### Patent Documents

Patent Document 1: Japanese Patent Application Laid-Open No. 2018-137208

### SUMMARY

### Problem to be Solved by the Invention

A wire harness (wiring member) is assembled to various positions such as an installment panel, a door, and a roof in a vehicle. These wiring members are manufactured to have a form in accordance with an assembling position and a specification, for example, thus have various types of configuration. When the wiring member is automatically assembled to a vehicle, a predetermined wiring member is desired to be specified easily in the plurality of wiring members.

An object is to provide a technique capable of easily specifying a predetermined wiring member.

### Means to Solve the Problem

A wiring member according to the present disclosure is a wiring member including: a plurality of wire-like transmission members; and a sheet to which the plurality of wire-like transmission members are fixed to be arranged side by side, wherein the sheet includes a first sheet covering the plurality of wire-like transmission members from one side and a second sheet covering the plurality of wire-like transmission members from another side, a window region is provided in a part of the sheet along a longitudinal direction of the plurality of wire-like transmission members, the window region is provided on a side directed to an outer surface in a state where the wiring member is folded, and a part of the plurality of wire-like transmission members wired in the window region can be identified.

### Effects of the Invention

According to the present disclosure, a predetermined wiring member can be easily specified.

### BRIEF DESCRIPTION OF DRAWINGS

FIG. 1 is a plan view illustrating a wiring member according to an embodiment.

FIG. 2 is a plan view illustrating a wiring member 10 in a folded state.

FIG. 3 is a cross-sectional view along a III-III line in FIG. 1.

FIG. 4 is a cross-sectional view along a IV-IV line in FIG. 1.

### DESCRIPTION OF EMBODIMENT(S)

### Description of Embodiment of Present Disclosure

Embodiments of the present disclosure are listed and described firstly.

A wiring member according to the present disclosure is as follows.

(1) A wiring member includes: a plurality of wire-like transmission members; and a sheet to which the plurality of wire-like transmission members are fixed to be arranged side by side, wherein the sheet includes a first sheet covering the plurality of wire-like transmission members from one side and a second sheet covering the plurality of wire-like transmission members from another side, a window region is provided in a part of the sheet along a longitudinal direction of the plurality of wire-like transmission members, the window region is provided on a side directed to an outer surface in a state where the wiring member is folded, and a part of the plurality of wire-like transmission members wired in the window region can be identified. The part of the plurality of wire-like transmission members wired in the window region is identified, thus a type of the wiring member, for example, is identified. The wiring member is transported to an assembly operation position in a folded state and developed in the assembly operation position in many cases. Even in this case, the window region is provided on a side directed to an outer surface in a state where the wiring member is folded, thus a predetermined wiring member in a folded state in the assembly operation position can be specified easily.

(2) It is applicable that the plurality of wire-like transmission members are wired in a form including a main wire part and a branch wire part, the sheet includes a main wire fixing part to which the main wire part is fixed and a branch wire fixing part to which the branch wire part is fixed, and the window region is provided in the branch wire fixing part. The branch wire part can also be specified in addition to the specification of the wiring member using the window region.

(3) It is applicable that the branch wire part includes a first branch wire part and a second branch wire part, the window region includes a first window region provided in a position corresponding to the first branch wire part and a second window region provided in a position corresponding to the second branch wire part, and an appearance of the plurality of wire-like transmission members in the first window region and an appearance thereof in the second window region are different from each other. Accordingly, the plurality of branch wire parts can also be identified using the window region.

(4) The window region may be provided in a position which is exposed outside in a state where the wiring member is folded. Accordingly, it is suppressed that folded portions are overlapped with each other and the window region goes out of sight.

(5) The sheet may further include a transparent sheet covered on the window region. Accordingly, both the sheet and the window region are provided.

### Details of Embodiment of Present Disclosure

Specific examples of a wiring member of the present disclosure are described hereinafter with reference to the drawings. The present invention is not limited to these examples, but is indicated by claims, and it is intended that meanings equivalent to claims and all modifications within a scope of claims are included.

### Embodiment

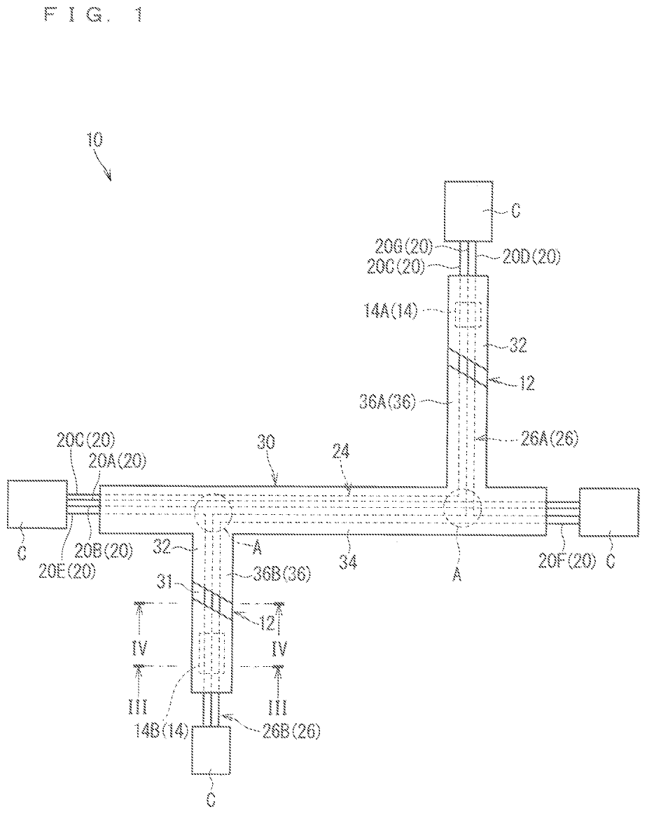

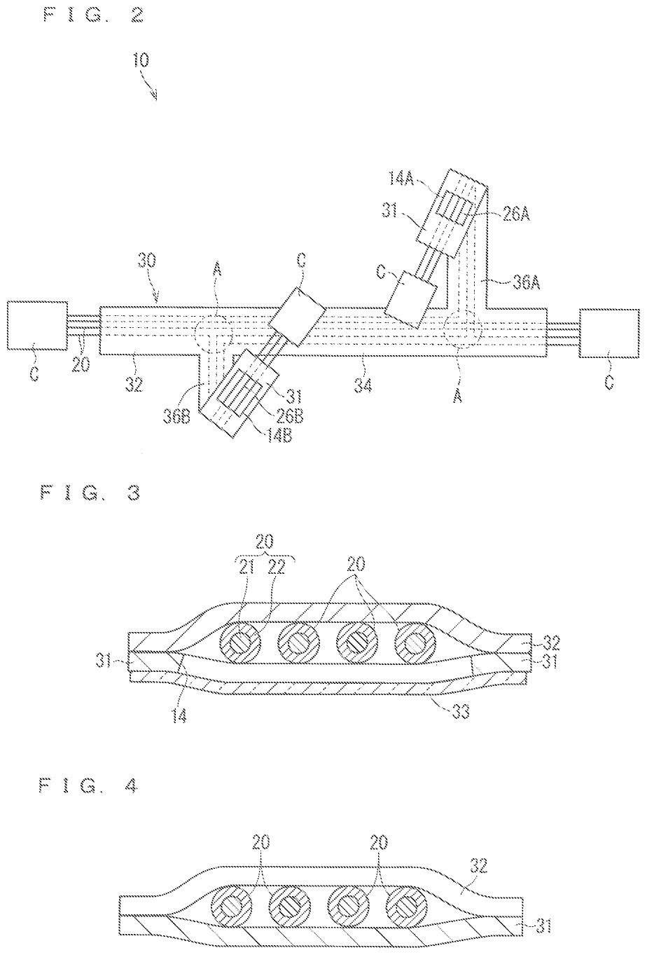

A wiring member according to an embodiment is described hereinafter. FIG. 1 is a plan view illustrating a wiring member 10 according to the embodiment. FIG. 2 is a plan view illustrating a wiring member 10 in a folded state. FIG. 3 is a cross-sectional view along a III-II line in FIG. 1. FIG. 3 is a cross-sectional view along a IV-IV line in FIG. 1.

The wiring member 10 includes a plurality of wire-like transmission members 20 and a sheet 30. The plurality of wire-like transmission members 20 are wired in a form including a main wire part 24 and a branch wire part 26.

It is sufficient that the wire-like transmission member 20 is a wire-like member transmitting an electrical power or light, for example. For example, the wire-like transmission member 20 may be a general wire having a core wire 21 and a covering 22 around the core wire 21, or may also be a bare conductive wire, a shielded wire, an enamel wire, a nichrome wire, or an optical fiber.

The wire-like transmission member 20 transmitting the electrical power may be various kinds of signal lines or various kinds of power lines. The wire-like transmission member 20 transmitting the electrical power may be used as an antenna or coil, for example, transmitting or receiving a signal or electrical power to or from a space.

The wire-like transmission member 20 includes a transmission wire body transmitting an electrical power or light and a covering for covering the transmission wire body. When the wire-like transmission member 20 is a general wire, the transmission wire body is a core wire 21, and the covering is an insulating covering 22. The core wire 21 may be made up of a plurality of single wires. The plurality of single wires may be stranded. In the example illustrated in FIG. 3, the plurality of wire-like transmission members 20 having the same diameter and structure are disposed on one sheet 30, however, it is sufficient that the diameter and the structure of each of the plurality of wire-like transmission members 20 are appropriately set, thus the wire-like transmission members 20 each having a different diameter and a structure, for example, may be disposed on the same sheet 30.

The wire-like transmission member 20 may be a single wire-like object or a composite object of a plurality of wire-like objects (a twisted wire and a cable made up of a plurality of wire-like objects covered by a sheath). A terminal and a connector C, for example, are appropriately provided in accordance with a connection state of the wire-like transmission member 20 and the other side member in an end portion of the wire-like transmission member 20.

The plurality of wire-like transmission members 20 are wired to have a configuration including a main wire part 24 and a branch wire part 26. The two branch wire parts 26 are provided herein. The two branch wire parts 26 are distinguished as a first branch wire part 26A and a second branch wire part 26B in some cases hereinafter.

The first branch wire part 26A is branched from one side portion in the main wire part 24, and the second branch wire part 26B is branched from the other side portion in the main wire part 24. The first branch wire part 26A and the second branch wire part 26B are branched from positions different from each other along a longitudinal direction of the main wire part 24. A longitudinal direction of the first branch wire part 26A and the second branch wire part 26B are perpendicular to the longitudinal direction of the main wire part 24. Needless to say, routes of the main wire part 24 and the branch wire part 26 are not limited thereto described above. For example, one branch wire part 26 may be provided, or three or more branch wire parts 26 may also be provided. For example, the two branch wire parts 26 may be branched from one side portion in the main wire part 24. For example, the two branch wire parts 26 may be branched from the same position along the longitudinal direction of the main wire part 24. For example, the longitudinal direction of the branch wire part 26 may not be parallel and perpendicular to the longitudinal direction of the main wire part 24. That is to say, the longitudinal direction of the branch wire part 26 may intersect with the longitudinal direction of the main wire part 24 at an angle larger than 0 degree and smaller than 90 degrees.

In the example illustrated in FIG. 1, the seven wire-like transmission members 20 are disposed on the sheet 30. The seven wire-like transmission members 20 are disposed along predetermined routes, respectively. The seven wire-like transmission members 20 are distinguished as the wire-like transmission members 20A, 20B, 20C, 20D, 20E, 20F, and 20G in some cases hereinafter. Specifically, the wire-like transmission members 20A and 20B are wired to constitute only the main wire part 24 on the sheet 30. The wire-like transmission members 20C and 20D are wired so that some of them constitutes the main wire part 24 and the other some of them constitutes the first branch wire part 26A on the sheet 30. The wire-like transmission members 20E and 20F are wired so that some of them constitutes the main wire part 24 and the other some of them constitutes the second branch wire part 26B on the sheet 30. The wire-like transmission member 20G is wired so that an intermediate portion thereof constitutes the main wire part 24, one end portion thereof constitutes the first branch wire part 26A, and the other end portion thereof constitutes the second branch wire part 26B on the sheet 30.

The wire-like transmission member 20 is fixed to the sheet 30. The sheet 30 keeps a wiring state of the wire-like transmission member 20. The sheet 30 includes a first sheet 31 and a second sheet 32 herein. The first sheet 31 covers one side of the wire-like transmission member 20. The second sheet 32 covers the other side (a side opposite to the first sheet 31) of the wire-like transmission member 20. An intermediate portion in the wire-like transmission member 20 is surrounded by the first sheet 31 and the second sheet 32. Accordingly, suppressed is an exposure of the intermediate portion in the wire-like transmission member 20.

Herein, the wire-like transmission member 20 is fixed to only the first sheet 31 in the first sheet 31 and the second sheet 32. A fixing state of the wire-like transmission member 20 and the first sheet 31 is not particularly limited, however, bonding or welding may also be applied. The bonding indicates that two members are bonded to each other via an inclusion such as an adhesive agent or a double-sided adhesive tape. The welding indicates that resin contained in at least one of two members are melted and the two members are welded to each other without an intervention of an inclusion. Herein, at least one of resin contained in the covering 22 of the wire-like transmission member 20 and resin contained in the first sheet 31 is melted and bonded to the other side member, thus the wire-like transmission member 20 and the first sheet 31 are fixed to each other.

Materials constituting the first sheet 31 and the second sheet 32 are not particularly limited, however, the first sheet 32 and second sheet 32 are formed of materials containing resin of polyvinyl chloride (PVC), polyethylene terephthalate (PET), polypropylene (PP), or nylon, for example. The first sheet 31 and the second sheet 32 may be a fibrous material having fiber such as a non-woven cloth, a woven fabric, or a knitting fabric or a non-fiber material, for example. The non-fiber material may be a solid member with an inner portion evenly filled or a foam made up by foam molded resin. The first sheet 31 and the second sheet 32 may contain a material such as metal, for example.

The first sheet 31 and the second sheet 32 may be a single layer or may be a plurality of stacked layers. When the first sheet 31 and the second sheet 32 are made up of the plurality of stacked layers, it is considered that a resin layer and a resin layer are stacked, for example. It is also considered that a resin layer and a metal layer are stacked, for example. The first sheet 31 and the second sheet 32 may be made up of a non-fiber material layer and a non-fiber material layer overlapped with each other, a non-fiber material layer and a fiber material layer overlapped with each other, or a fiber material layer and a fiber material layer overlapped with each other.

The first sheet 31 has a double-layered structure, for example. A first layer in the first sheet 31 is a layer appropriate for fixation to the wire-like transmission member 20. For example, the first layer is formed into a solid member, with an inner portion evenly filled, of the same material as that of the covering 22 of the wire-like transmission member 20. The wire-like transmission member 20 is fixed on the first layer. The second layer is a layer enhancing a function of the sheet 30. The second layer is a non-woven cloth, for example. The first layer may be wholly or partially provided on the second layer. For example, the first layer may be provided only in an intermediate portion along a width direction of the second layer (a parallel direction of the wire-like transmission member 20), and needs not be provided in a side edge portion. For example, the first layer may be provided at intervals along the longitudinal direction of the second layer (the longitudinal direction of the wire-like transmission member 20).

The second sheet 32 has a single-layered structure, for example. The second sheet 32 is formed to have higher rigidity than the first sheet 31. The second sheet 32 is formed to be a member of nylon as a material with an inner portion evenly filled, for example. The wire-like transmission member 20 is not fixed to the second sheet 32. An edge portion of the second sheet 32 is fixed to the first sheet 31. A fixing state of the first sheet 31 and the second sheet 32 is not particularly limited, however, welding or bonding is also applicable. The second sheet 32 may be fixed to the first layer or the second layer in the first sheet 31.

The sheet 30 includes a main wire fixing part 34 and a branch wire fixing part 36. The main wire fixing part 34 is a part where the main wire part 24 is fixed. The branch wire fixing part 36 is a part where the branch wire part 26 is fixed. The branch wire fixing part 36 is branched from the branch wire fixing part 34. That is to say, the branch wire fixing part 36 is connected to the main wire fixing part 34. Herein, the branch wire fixing part 36 is branched from an intermediate portion of the branch wire fixing part 34 in a longitudinal direction. The branch wire fixing part 36 includes a first branch wire fixing part 36A and a second branch wire fixing part 36B. The first branch wire fixing part 36A is a part where the first branch wire part 26A is fixed. The second branch wire fixing part 36B is a part where the second branch wire part 26B is fixed.

The wiring member 10 is provided with an easy-bending part 12. The easy-bending part 12 is provided in a region where the sheet 30 is located. The easy-bending part 12 is a part where the second sheet 32 is provided at intervals along the longitudinal direction of the wire-like transmission member 20. That is to say, the easy-bending part 12 is a part where the second sheet 32 is not located along the longitudinal direction of the wire-like transmission member 20. Described above is the configuration that the second sheet 32 is not included, however, the configuration is not limited thereto. For example, it is sufficient that rigidity of the second sheet 32 in a position corresponding to the easy-bending part 12 is set to be lower than that of the second sheet 32 in a region except for the easy-bending part 12. That is to say, the easy-bending part may be formed into a shape capable of partially bending the second sheet 32 easily. An accordion-like shape is also applicable as the shape capable of bending the second sheet 32 easily. The accordion-like part is a part formed into an accordion-like shape in which a mountain and a valley are alternately and sequentially located in the longitudinal direction of the wire-like transmission member 20. When a terminal side portion is bended at a position of the easy-bending part 12, the wiring member 10 is folded.

One example of the easy-bending part 12 is described above, however, it is sufficient that the easy-bending part 12 has a shape of being partially bended easily such as a fold line (not shown), for example, thus the shape thereof is not particularly limited. For example, also applicable is a shape in which a slit (not shown) is provided not in the second sheet 32 but in the first sheet 31 to form the easy-bending part 12.

The wiring member 10 is provided with a vacuum suction position. In the example illustrated in FIG. 1, a region A illustrated by a dashed-two dotted line is the vacuum suction position. In the example illustrated in FIG. 1, two vacuum suction positions are set. The vacuum suction position is set in a position where the wiring member 10 is hardly inclined when the wiring member 10 is vacuum-sucked at the position and raised and can substantially maintain balance. The number of vacuum suction positions in one wiring member 10 is not limited to two. For example, when the wiring member 10 is relatively small, one vacuum suction position may be provided. For example, when the wiring member 10 is relatively large, three or more vacuum suction positions may be provided. When the wiring member 10 is folded, it is sufficient that the vacuum suction position is provided in a position exposed in the wiring member 10 in a folded state. The vacuum suction is described as the suction configuration for convenience, however, it is obvious that the suction configuration is not limited to the vacuum suction. It is sufficient that negative pressure large enough to suck and raise the wiring member 10 is applied.

The wiring member 10 is provided with a window region 14. When the wiring member 10 is observed from outside, a part of the plurality of wire-like transmission members 20 wired in the window region 14 can be identified. A method of identifying the part of the plurality of wire-like transmission members 20 wired in the window region 14 is not particularly limited. For example, the part may be identified by an identification device or an operator based on a captured image captured by an imaging element. The part may also be identified by an operator visually recognizing the part, for example. The window region 14 is provided in a part of the sheet 30 along the longitudinal direction of the plurality of wire-like transmission members 20.

A position of the window region 14 along the longitudinal direction of the plurality of wire-like transmission members 20 is not particularly limited. The window region 14 may also be provided in a position at which the wire-like transmission members 20 may be exposed with no problem, for example. For example, a first protection region and a second protection region are set in a portion in the wiring member 10 where the sheet 30 is provided. The second protection region is a position which needs to be protected more than the first protection region. The position which needs to be protected more is a position easily interfering with a surrounding member in the wiring member 10 or a position significantly influenced by heat, for example. It is sufficient that the window region 14 is provided not in the second protection region but in the first protection region. A transparent sheet 33 is provided for protecting the wire-like transmission member 20 in the window region 14 herein, however, when there is a low necessity of protecting the wire-like transmission member 20, the transparent sheet 33 may be omitted.

The window region 14 is provided in the branch wire fixing part 36. The window region 14 includes a first window region 14A and a second window region 14B. The first window region 14A is provided in a position corresponding to the first branch wire part 26A. The first window region 14A is provided in the first branch wire fixing part 36A. The second window region 14B is provided in a position corresponding to the second branch wire part 26B. The second window region 14B is provided in the second branch wire fixing part 36B.

The window region 14 is provided on a side directed to an outer surface in a state where the wiring member 10 is folded. Herein, the wiring member 10 is folded with the second sheet 32 inside. Then, the window region 14 is provided closer to the terminal side portion in relation to a bending position in the wiring member 10. Thus, the window region 14 is provided closer to a side of the first sheet 31 directed to the outer surface in the terminal side portion in relation to the bending position. Needless to say, the window region may be provided in the second sheet 32. In the description hereinafter, a configuration according to the window region 14 is provided in the first sheet 31. The configuration according to the window region 14 hereinafter can also be appropriately applied to a case where the configuration thereof is provided in the second sheet 32 so far as consistent with the embodiments.

The window region 14 is a portion where a part of the first sheet 31 along the longitudinal direction is not partially present. Herein, the window region 14 is set in an intermediate portion of the first sheet 31 in a width direction. A through hole is formed in a thickness direction in a portion of the first sheet 31 corresponding to the window region 14. The first sheet 31 is located adjacent to the window region 14 along the width direction of the first sheet 31. The portion located adjacent to the window region 14 along the width direction of the first sheet 31 is fixed to the second sheet 32.

However, the window region 14 may be provided to extend to one end portion along the width direction of the first sheet 31 or extend to both end portions. In the latter case, the first sheet 31 is completely divided by the window region 14. That is to say, the first sheet 31 is provided at intervals along the longitudinal direction of the wire-like transmission member 20, and the portion between the first sheet 31 constitutes the window region.

When the window region 14 is provided in a part along the width direction of the first sheet 31, it is sufficient that a width dimension of the window region 14 and the position thereof along the width direction is set so that at least a part of the wire-like transmission members 20 can be identified. The width dimension of the window region 14 and the position along the width direction may also be set so that all of the wire-like transmission members 20 constituting the branch wire part 26 where the window region 14 is formed can be identified.

The window region 14 is formed by cutting off a part of the first sheet 31, which uniformly extends, corresponding to the window region 14, for example. At this time, the first sheet 31 may be previously cut off before or after the process of fixing the wire-like transmission member 20. In the latter case, it is sufficient that the wire-like transmission member 20 is not fixed to the part of the first sheet 31 which is cut off.

The window region 14 is provided in a position which is exposed outside in a state where the wiring member 10 is folded. The position which is exposed outside in the state where the wiring member 10 is folded indicates a position directed outward in the wiring member 10 and the folded terminal side portion does not overlap therewith. Herein, the window region 14 is provided closer to the terminal side in relation to the bending position, thereby being provided in the position which is exposed outside in the state where the wiring member 10 is folded.

The sheet 30 further includes the transparent sheet 33. The transparent sheet 33 covers the window region 14. Herein, the first sheet 31 is not provided in the window region 14. Thus, the transparent sheet 33 covers the window region 14 in place of the first sheet 31. The transparent sheet 33 may be located on an outer side or an inner side of the first sheet 31.

The transparent sheet 33 may be fixed to the first sheet 31, the wire-like transmission member 20, or the second sheet 32. A fixing state of the transparent sheet 33 and the fixation target is not particularly limited, however, bonding or welding may also be applied. It is sufficient that the transparent sheet 33 is formed to be larger than the window region 14 and a peripheral edge part of the outer side of the window region 14 is fixed to the fixation target, for example.

A thickness dimension of the transparent sheet 33 is not particularly limited. The thickness dimension of the transparent sheet 33 may be equal to, larger than, or smaller than that of the first sheet 31. The thickness dimension of the transparent sheet 33 may be equal to, larger than, or smaller than that of the second sheet 32.

A color of the first sheet 31 and the second sheet 32 is particularly limited. One of the first sheet 31 and the second sheet 32 partitioning the window region 14 (the first sheet 31 herein) may have a color different from the wire-like transmission member 20. One of the first sheet 31 and the second sheet 32 functioning as a background of the window region 14 (the second sheet 32 herein) may have a color different from the wire-like transmission member 20. The color of the first sheet 31 and the color of the second sheet 32 may be the same as of different from each other. The first sheet 31 and the second sheet 32 may have lower transparency than the transparent sheet 33. A color of the transparent sheet 33 is not particularly limited, however, a colorless transparent sheet 33 is also applicable.

It is sufficient that the window region 14 is located near a position as a basis (referred to as a reference position hereinafter) when a robot assembles the wiring member 10 in the folded state to a vehicle. Accordingly, the robot can recognize both the window region 14 and the reference position easily.

A holding position where the robot holds the wiring member 10 in the folded state such as the vacuum suction position described above, for example, may be the reference position. In addition to the vacuum suction position, a grasping position, for example, is considered as the position where the robot holds the wiring member 10 in the folded state. The grasping position is a position where the robot grasps the wiring member 10 in the folded state. A structure appropriate for the robot to hold the wiring member 10 may be given to the holding position. Furthermore, the structure may be peculiar in appearance in the wiring member 10.

Examples of the reference position include, in addition to the holding position, a vehicle fixing position where the wiring member 10 in the folded state is fixed to the vehicle. A structure for fixation may be given to the vehicle fixing position. For example, it is considered that a fixing member is provided to have a form capable of fixing the wiring member 10 in the folded state to the vehicle or receiving part to which a fixing member on a vehicle side is fixed is provided in the vehicle fixing position.

When the wiring member 10 is folded, the window region 14 may be located in a position getting closer to the reference position in relation to a position thereof in the state before the wiring member 10 is folded (developed state). Herein, the window region 14 is located closer to the terminal side in relation to the bending position, and the terminal side portion is provided in a position closer to the holding position as the reference position in relation to the bending position. Thus, the window region 14 is provided in a position closer to the reference position in relation to a position thereof in the state before the wiring member 10 is folded.

When the wire-like transmission member 20 wired in the window region 14 is identified, a type of the wiring member 10, for example, is identified. An identification state is not particularly limited, however, the type thereof can be identified in accordance with a difference of a size of the window region 14, an area in the window region 14 (an area of the wire-like transmission member 20), a color of the wire-like transmission member 20 wired in the window region 14 (a color of the covering 22), and a position of the widow region 14 (a distance from the connector C), for example. That is to say, in the plural types of wiring member 10, the size of the window region 14 is different, the area in the window region 14 is different, the color of the wire-like transmission member 20 wired in the window region 14 is different, and the position of the window region 14 is different, thus the type thereof, for example, is identified.

Further herein, the plurality of branch wire parts 26 are also identified by the window region 14 in the wiring member 10. In this case, in identifying the window region 14, it is sufficient that a plurality of identification states such as the size of the window region 14, the area in the window region 14 (the area of the wire-like transmission member 20), the color of the wire-like transmission member 20 wired in the window region 14 (the color of the covering 22), and the position of the widow region 14 (the distance from the connector C) are identified, for example, are identified. That is to say, it is sufficient that an identification state used for identifying the type of the wiring member 10, for example, and an identification state used for identifying the plurality of branch wire parts 26 are different from each other.

Specifically, a first identification state is set for the first window region 14A and the second window region 14B in one wiring member 10. The first identification state is used for identifying one wiring member 10 and the other wiring member. Accordingly, the first window region 14A and the second window region 14B are formed to have a common appearance in a viewpoint of the first identification state. For example, a color of the wire-like transmission member 20 in the first window region 14A and the second window region 14B is common in one wiring member 10. This color is different from that of the wire-like transmission member of the other wiring member in the window region. Accordingly, one wiring member 10 and the other wiring member can be identified. A second identification state is set for the first window 14A and the second window region 14B in one wiring member 10. The second identification state is used for identifying the first branch wire part 26A and the second branch wire part 26B. Accordingly, the first window region 14A and the second window region 14B are formed to have different appearances in a viewpoint of the second identification state. For example, an area of the wire-like transmission member 20 is different in the first window region 14A and the second window region 14B. Accordingly, the first branch wire part 26A and the second branch wire part 26B can be identified in one wiring member 10.

### Effect Etc. of Embodiments

According to the wiring member 10 having the above configuration, the part of the plurality of wire-like transmission members 20 wired in the window region 14 is identified, thus the type of the wiring member 10, for example, is identified. The wiring member 10 is transported to an assembly operation position in a folded state and developed in the assembly operation position in many cases. Even in this case, the window region 14 is provided on a side directed to an outer surface in a state where the wiring member 10 is folded, thus a predetermined wiring member 10 in a folded state in the assembly operation position can be specified easily.

The window region 14 is provided in the branch wire part 26, thus branch wire part 26 can also be specified in addition to the specification of the wiring member 10 using the window region 14.

The appearance of the plurality of wire-like transmission members 20 in the first window region 14A and the appearance thereof in the second window region 14B are different from each other, thus the first branch wire part 26A and the second branch wire part 26B can be identified.

The window region 14 is provided in a position exposed outside in a folded state, thus it is suppressed that folded portions are overlapped with each other and the window region 14 goes out of sight.

The transparent sheet 33 covers the window region 14, thus both the sheet 30 and the window region 14 can be provided.

[Modification example] The window region 14 needs not be provided in the branch wire fixing part 26. The window region 14 may be provided in the main wire part 24. The plurality of wire-like transmission members 20 may not be wired in a form including the main wire part 24 and the branch wire part 26.

When the plurality of branch wire parts 26 are provided, the window region 14 may be provided only in some of the plurality of branch wire parts 26 or only in one branch wire part 26. When the window regions 14 are provided in the plurality of branch wire parts 26, appearances thereof need not be different from each other. For example, when the type of the wiring 10 is desired to be specified by identifying one of the plurality of window region 14, the plurality of window regions 14 may have a common appearance.

Each configuration described in the embodiment and each modification example can be appropriately combined as long as they are not contradictory.

### EXPLANATION OF REFERENCE SIGNS

10 wiring member
12 easy-bending part
14 window region
14A first window region
14B second window region
20, 20A, 20B, 20C, 20D, 20E, 20F, 20G wire-like transmission member
21 core wire
22 covering
24 main wire part
26 branch wire part
26A first branch wire part
26B second branch wire part
30 sheet
31 first sheet
32 second sheet
33 transparent sheet
34 main wire fixing part
36 branch wire fixing part
C connector
A region

1. A wiring member, comprising:
a plurality of wire-like transmission members; and
a sheet to which the plurality of wire-like transmission members are fixed to be arranged side by side, wherein
the sheet includes a first sheet covering the plurality of wire-like transmission members from one side and a second sheet covering the plurality of wire-like transmission members from another side,
a window region is provided in a part of the sheet along a longitudinal direction of the plurality of wire-like transmission members,
the window region is provided on a side directed to an outer surface in a state where the wiring member is folded, and
a part of the plurality of wire-like transmission members wired in the window region can be identified.

2. The wiring member according to claim 1, wherein
the plurality of wire-like transmission members are wired in a form including a main wire part and a branch wire part,
the sheet includes a main wire fixing part to which the main wire part is fixed and a branch wire fixing part to which the branch wire part is fixed, and
the window region is provided in the branch wire fixing part.

3. The wiring member according to claim 2, wherein
the branch wire part includes a first branch wire part and a second branch wire part,
the window region includes a first window region provided in a position corresponding to the first branch wire part and a second window region provided in a position corresponding to the second branch wire part, and
an appearance of the plurality of wire-like transmission members in the first window region and an appearance of the plurality of wire-like transmission members in the second window region are different from each other.

4. The wiring member according to claim 1, wherein
the window region is provided in a position which is exposed outside in a state where the wiring member is folded.

5. The wiring member according to claim 1, wherein
the sheet further includes a transparent sheet covered on the window region.
